(19) United States
(12) Patent Application Publication
(10) Pub. No.: US 2026/0181652 A1
(43) Pub. Date: Jun. 25, 2026

(54) SYSTEMS, METHODS, AND DEVICES FOR SIDELINK (SL) COMMUNICATONS

(71) Applicant: Apple Inc., Cupertino, CA (US)

(72) Inventors: Chunhai Yao, Beijing (CN); Chunxuan Ye, San Diego, CA (US); Dawei Zhang, Saratoga, CA (US); Wei Zeng, Saratoga, CA (US); Haitong Sun, Saratoga, CA (US); Hong He, San Jose, CA (US); Huaning Niu, San Jose, CA (US); Weidong Yang, San Diego, CA (US); Ankit Bhamri, Haar (DE); Seyed Ali Akbar Fakoorian, San Diego, CA (US)

(21) Appl. No.: 19/126,345

(22) PCT Filed: Nov. 4, 2022
(86) PCT No.: PCT/CN2022/130122

§ 371 Date: May 1, 2025

(51) Int. Cl. H04W 72/23; H04L 5/00

(52) U.S. Cl. CPC H04W 72/23; H04L 5/0053

(57) ABSTRACT

The techniques described herein provide solutions for SL signaling that supports two candidate starting symbols within a slot. Slots with two candidate starting symbols may not be applicable to slots with feedback channel resources. Slots with two candidate starting symbols may be preconfigured. Slot structures and solutions for determining transport block size (TBS), for slots supporting two candidate starting symbols, are provided. Also described are solutions for processing time constraints and time gaps between reception of slots supporting two candidate starting symbols and providing feedback regarding such slots. Techniques described herein also include solutions for sharing information during overlapping long-term evolution (LTE) and new radio (NR) sensing windows, sharing LTE and NR sub-channel resources, and avoiding NR feedback transmission that may overlap with LTE transmissions. These and other features and techniques are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) to communicate with one another directly.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example process sidelink (SL) communications in the unlicensed spectrum (SL-U communications) according to one or more implementations described herein.

FIG. 3 is a diagram of an example of a slot with two candidate starting symbols according to one or more implementations described herein.

FIGS. 4-5 are diagrams of examples of slot configurations supporting two start symbols in one slot according to one or more implementations described herein.

FIG. 6 is a diagram of an example of an long-term evolution (LTE) sensing module 610 and an new radio (NR) sensing module of a user equipment (UE) according to one or more implementations described herein.

FIG. 7 is a diagram of an example of overlapping LTE and NR sensing windows and sharing LTE sensing results according to one or more implementations described herein.

FIG. 8 is a diagram of an example of a process for sharing and using sensing results according to one or more implementations described herein.

FIG. 9 is a diagram of an example of a process for using shared LTE signal results according to one or more implementations described herein.

FIGS. 10-11 are diagrams of examples of using shared LTE signal results according to one or more implementations described herein.

FIGS. 12-13 are diagrams of examples of preventing physical SL feedback channel (PSFCH) transmissions from overlapping with LTE transmissions according to one or more implementations described herein.

FIG. 14 is a diagram of an example of components of a device according to one or more implementations described herein.

FIG. 15 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device.

UEs may utilize one or more types of communication technologies to communicate directly with one another. Examples of such technologies may include proximity-based service (ProSe) or device-to-device (D2D) communications, vehicle-to-anything (V2X) communications, sidelink (SL) communications, and more. SL communications, as described herein, may include a scenario in which a UE operates to discover, establish a connection, and communicate, with one or more other UEs directly. SL communications using the unlicensed wireless spectrum may be referred to as SL-U communications.

SL transmissions may use Time Division Duplex (TDD) (e.g., half duplex) on a dedicated carrier or a shared carrier with conventional Uu transmissions between a base station and UE. Transmission resource pools (also referred to as resource pools, SL resource pools, etc.) may be used to manage resource allocation and interference between conflicting transmissions. A resource pool may include a set of time-frequency resources from which resources for an SL transmission may be selected. And UEs may be configured with multiple transmit and receive resource pools.

Additionally, UEs may use different modes of operation for SL resource allocation and communication. Mode 1 may be used when UEs are within a coverage area of a base station. In mode 1, scheduling and resource assignment may be performed by the base station (e.g., via DCI and may be based on a dynamic grant (DG) or configured grant (CG). Mode 2 may be used when UEs are outside the coverage area of base stations. In mode 2, UEs may select SL resources by themselves (e.g., without a base station). As such, UEs may use sensing-based resource allocation, which may include performing a listen-before-talk (LBT) procedure before selecting SL resources for use and transmitting SL control information (SCI) to other UEs to indicate the use and reservation of the SL resources. In some implementations, UEs may also use a channel occupancy time (COT) to indicate how long certain resources (e.g., a channel) is to be used. The SCI may be transmitted via unicast, groupcast, and/or broadcast, and may indicate recipient UEs, which SL resources are scheduled for use. The SCI may indicate the reserved SL resources for both a first transmission of a transport block (TB) of data, and for retransmission of the TB to improve reliability (e.g., if the initial transmission fails).

Currently available techniques fail to provide adequate solutions for SL-U communications—and particularly with respect to starting symbols, slot structures, and SL-U resource allocations and conflicts. For example, currently available techniques fail to provide support for slot structures that include slots with two candidate starting symbols and feedback resources, determining transport block size (TBS) when a slot includes two candidate starting symbols, and resolving SL-U signaling and processing time constraints for such scenarios. Currently available techniques also fail to provide solutions for resolving SL communications that involve LTE resources and NR resources, converting LTE resource preferences into NR resource preferences, and resolving potential resource conflicts between LTE SL resource reservations and NR SL resources.

The techniques described herein provide solutions for these and other deficiencies of the current technology. These techniques include solutions for SL signaling that supports two candidate starting symbols within a slot. Slots with two candidate starting symbols may not be applicable to slots with feedback channel resources. Slots with two candidate starting symbols may be (pre) configured. Slot structures and solutions for determining TBS, for slots supporting two candidate starting symbols, are provided. Also described are solutions for processing time constraints and time gaps between reception of slots supporting two candidate starting symbols and providing feedback regarding such slots. Techniques described herein also include solutions for sharing information during overlapping LTE and NR sensing windows, sharing LTE and NR sub-channel resources, and avoiding NR feedback transmission that may overlap with LTE transmissions. These and other features and techniques are described below with reference to the Figures.

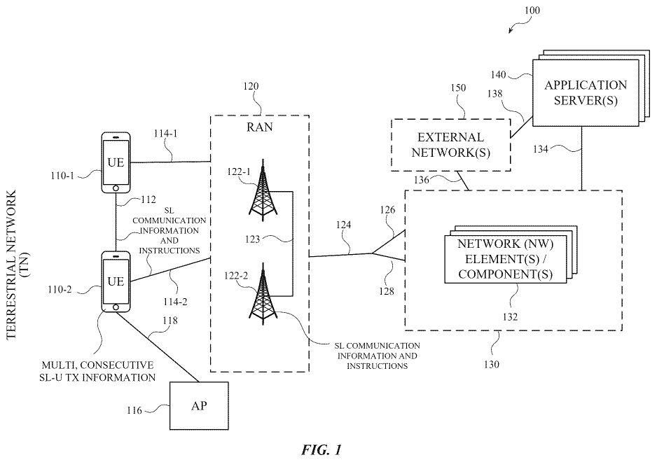

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, SL connection, etc. The connection may involve a PC5 interface. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may use one or more wireless channels 112 to communicate with one another. As described herein, UE 110-1 may communicate with RAN node 122 to request SL resources. RAN node 122 may respond to the request by providing UE 110 with a dynamic grant (DG) or configured grant (CG) regarding SL resources. A DG may involve a grant based on a grant request from UE 110. A CG may involve a resource grant without a grant request and may be based on a type of service being provided (e.g., services that have strict timing or latency requirements). UE 110 may perform a clear channel assessment (CCA) procedure based on the DG or CG, select SL resources based on the CCA procedure and the DG or CG; and communicate with another UE 110 based on the SL resources. The UE 110 may communicate with RAN node 122 using a licensed frequency band and communicate with the other UE 110 using an unlicensed frequency band.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130.

As described herein, UE 110 and/or base station 122 may send, receive, process, and/or store, one or more configurations, instructions, and/or other types of information for enabling SL-U signaling that supports two candidate starting symbols within a slot. Slots with two candidate starting symbols may be preconfigured (e.g., via mode 1 or mode 2 SL resource allocation) and slots with two candidate starting symbols may not be applicable to slots with feedback channel resources. The SL-U signaling may also involve determining and/or using different slot structures, transport block sizes, and signal timing (e.g., timing between reception of slots supporting two candidate starting symbols and providing feedback regarding such slots). The SL-U signaling enabled may also include sharing information during overlapping LTE and NR sensing windows, converting LTE resource preferences to NR resources for SL-U communications, and avoiding NR feedback transmission that may overlap with LTE transmissions.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 116 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 1G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 1 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHz unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using stand-alone unlicensed operation, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. In some implementations, such as a standalone (SA) implementation, interface 123 may be an Xn interface. In some implementations, such as non-standalone (NSA) implementations, interface 123 may represent an X2 interface and an XN interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

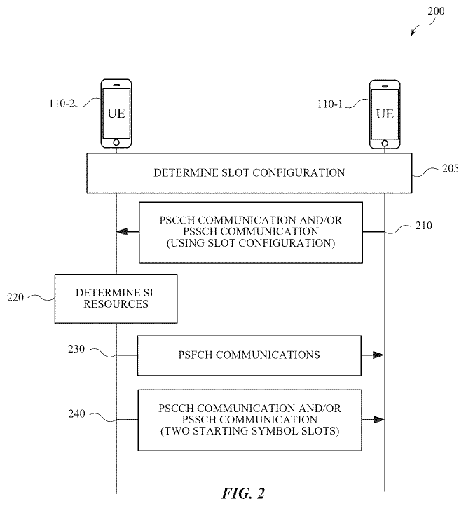

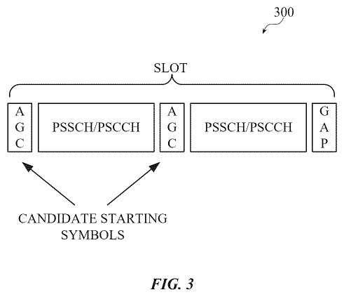

FIG. 2 is a diagram of an example process 200 for SL-U communications according to one or more implementations described herein. Process 200 may be implemented by UE 110-1 and UE 110-2. In some implementations, some or all of process 200 may be performed by one or more other systems or devices, including one or more of the devices of FIG. 1. Additionally, process 200 may include one or more fewer, additional, differently ordered and/or arranged operations than those shown in FIG. 2, including other processes and/or operations discussed herein. For example, process 200 may include operations preceding, performed in parallel with, and/or following one or more of the depicted operations. Furthermore, some or all of the operations of process 200 may be performed independently, successively, simultaneously, etc., of one or more of the other operations of process 200. As such, the techniques described herein are not limited to a number, sequence, arrangement, timing, etc., of the operations or process depicted in FIG. 2. Process 200 is described below with periodic reference to FIGS. 3-13.

As shown, process 200 may include UE 110-1 and UE 110-2 determining a slot configuration to use for SL communications (at 205). The slot configuration may include a slot with two candidate starting symbols and UE 110-1 and UE 110-2 may determine which starting symbol to use for PSSCH and PSCCH communications. In some implementations, the slot configuration may be determined between UE 110-1 and UE 110-2 (e.g., without participation of base station 110 (not shown)). In other implementations, the slot configuration may be determined based on a DG or CG from base station 110. In some implementations, the slot configuration may be determined by UE 110-1 and UE 110 in combination with determining SL resources.

Process 200 may also include UE 110-1 communicating an SL signal to UE 110-2 (at 210). The signal may include a PSCCH communication or a PSSCH communication. The communication may include slot configurations determined previously from a pool of SL resources some of which support two candidate starting symbols in one slot, along with other features such as symbols for PSCCH information, PSSCH information, etc. A starting symbol, as described herein, may include a symbol within a slot indicating a beginning of a PSCCH and/or PSSCH communication. A slot with two potential or candidate starting symbols may, for example, enable a PSCCH communication and/or PSSCH communication to be transmitted from the first starting symbol or the second starting symbol. Examples of a slot with two candidate starting symbols and slot configurations supporting slots with two candidate starting symbols are described below with reference to FIGS. 3-5.

FIG. 3 is a diagram of an example of a slot 300 with two candidate starting symbols according to one or more implementations described herein. As shown, slot 300 may include two automatic gain control (AGC) symbols, two sets of PSSCH/PSCCH symbols, and a gap symbol. In some implementations, a slot with two candidate starting symbols may use the AGC symbols as the starting symbols. Said another way, in some implementations, candidate starting symbols may be intended for AGC purposes. In some implementations, a slot with two candidate starting symbols may include a different arrangement of slots than that shown in FIG. 3. For example, the AGC symbols (or starting symbols) and/or PSSCH/PSCCH symbols may vary in size, number, and location within a slot. As such, FIG. 3 is provided as a non-limiting example.

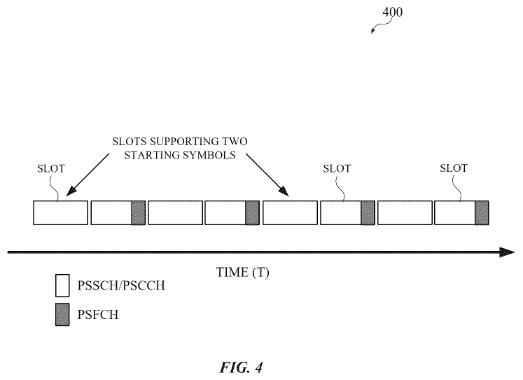

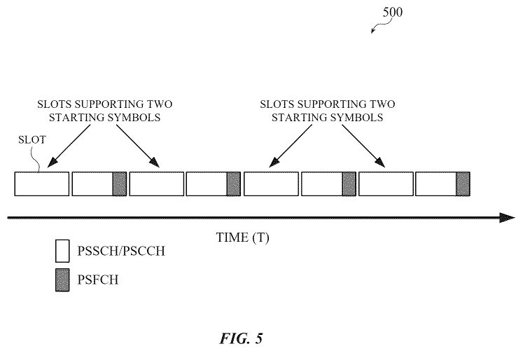

FIGS. 4-5 are diagrams of examples 400 and 500 of slot configurations supporting two candidate start symbols in one slot according to one or more implementations described herein. The slot configurations of examples 400 and 500 are non-limiting. For example, the techniques described herein may include or implement slot configurations with different arrangements, patterns, and periodicities of slots with two candidate starting symbols, slots with PSFCH resources, and slots with neither two candidate starting symbols nor PSFCH resources.

Example 400 may include a slot configuration with symbols for PSSCH/PSCCH communications and PSFCH communications. The slot configuration includes slots with two candidate starting symbols with a periodicity of four slots. Second starting symbols may not be applicable in a slot with PSFCH resources as three symbols may be used PSFCH resources (including two candidate symbols for the PSFCH and one gap symbol). As such, the remaining symbols in such slots may not be enough to meet the minimum needed for a PSSCH/PSCCH communication. Consequently, slots with two candidate starting symbols may not also include resources (e.g., symbols) for PSFCH communications. Similarly, example 400 may include a slot configuration with symbols for PSSCH/PSCCH communications and PSFCH communications. In example 500, every other slot is either a slot with two candidate starting symbols (e.g., a periodicity of a periodicity of two slots) or PSFCH resources. As such, when PSFCH resources are in a slot, then the slot may not also include a second starting symbol.

In some implementations, a slot configuration may be used that is based on a resource pool configuration. As described herein, the term “resource pool configuration” may refer to a set of SL resource pool configuration settings, a resource pool pre-configuration, or a resource pool (pre) configuration used to enable or facilitate one or more of the techniques described herein. In some implementations, one or more resource pool (pre) configurations may be received from base station 122 as part of a mode 1 SL resource allocation procedure (e.g., a DG or CG). In some implementations, UEs 110 may locally store one or more resource pool configurations and/or may communicate with one another to determine an appropriate resource pool configuration as part of a mode 2 SL resource allocation procedure. Depending on the scenario or implementation, not every slot may support two candidate starting symbols, and the feature of supporting two candidate starting symbols within a slot may be enabled or disabled based on the resource pool configuration. For example, a new control parameter, such as a “2_starting_symbols_in_slot” parameter or the like, may be used or indicated for one or more slots per the resource pool configuration.

In some implementations, a periodicity and starting position of slots with two candidate starting symbols may be used or indicated by the resource pool configuration. For example, one resource pool configuration may indicate a periodicity of four slots while another resource pool configuration may indicate a periodicity of two slots. In implementations using periodicity in a resource pool configuration, a periodicity of zero or infinity may be used to indicate that no slots have two candidate starting symbols.

In some implementations, the periodicity of slots with two candidate starting symbols may be predefined according to a rule or instruction. An example of such a rule may include a slot is to include two candidate starting symbols so long as the feature of slots with two candidate starting symbols is enabled per the resource pool configuration and the slot does not include PSFCH resources. In another example, a rule may include a slot is to not include PSFCH resources if the feature of slots with two candidate starting symbols is enabled and a particular slot is designated to have two candidate starting symbols.

In some implementations, the second starting symbol location (e.g., symbol index) may be pre-defined for all resource pool configurations or can be determined per resource pool resource pool configuration (e.g., different resource pool configurations may have different symbol locations for the second starting symbol). The second starting symbol location or index may be selected from a set of available symbol indexes (e.g., set={2, 3, 4, 5, 6, 7, 8}). In some implementations, the set of available symbol indexes may not include symbol indexes that pertain to PSSCH demodulated reference signal (DM-RS) symbols.

In some implementations, slots with two candidate starting symbols may also include two AGC symbols. The second AGC symbol may be set or designated to a location in the same manner as the second starting symbol (e.g., pre-defined for all resource pool configurations or determined per resource pool resource pool configuration). Additionally, the second AGC symbol may be a copy of the next symbol in the slot. For example, if the second ADC symbol is located at symbol index 5, the second AGC symbol may be the same (e.g., include the same information) as the symbol located at symbol index 6.

In some implementations, the PSSCH/PSCCH may be transmitted starting from the first starting symbol. In such implementations, PSSCH resource mapping may include coded bits and modulation symbols for the PSSCH being rate matched over the second AGC symbol location. Alternatively, resource mapping techniques without considering the second AGC symbol may be used for the PSSCH, such that the second AGC symbol location may be punctured first and then copied from the next OFDM symbol.

In the case of puncturing, suppose there are 1000 coded bits for a PSSCH, and the first 900 coded bits are carried in PSSCH symbols without considering the second AGC symbol. After that, consider a second AGC symbol and remove the coded bits from the second AGC symbol. Lastly, copy the next OFDM symbol after the second AGC symbol to the second AGC symbol. This may be an example of puncturing.

In some implementations, when a DM-RS symbol of a PSSCH may overlap with the second AGC symbol, the DM-RS symbol may be punctured by the second AGC symbol. Alternatively, when a DM-RS symbol of a PSSCH may overlap with the second AGC symbol, the DM-RS symbol may be advanced (e.g., moved to a preceding symbol index) or delayed by one or more symbols (e.g., moved to a subsequent symbol index). When the PSSCH/PSCCH is transmitted starting from the second starting symbol, the symbol index for the DM-RS symbol may be determined based on the number of remaining PSSCH symbols.

In scenarios where a resource pool configuration (or (pre) configuration) supports two candidate starting symbols, a TBS may be determined. In some implementations, the resource pool configuration may indicate whether the TBS determination is based on the slot from the first starting symbol or the slot of the second starting symbol. In other implementations, whether the TBS determination is based on the slot from the first starting symbol or the slot of the second starting symbol may be predefined or configured to be the same for all (or regardless of) the resource pool configuration.

In other implementations, whether the TBS determination is based on the slot from the first starting symbol or the slot of the second starting symbol may be indicated directly by 1st stage SCI (e.g., SCI indicating a first PSSCH DM-RS pattern of the DM-RS multiplexed with the PSSCH). In such implementations, a reserved bit in the 1st stage SCI (e.g., SCI Format 1-A) may be used provided that 2 starting symbols within a slot is enabled. For example, when the reserved bit is equal to 0, then TBS determination may be based on the slot from the first starting symbol, and when the reserved bit is equal to 1, then TBS determination may be based on the slot from the second starting symbol. In some implementations, when a higher layer parameter (e.g., an “indicationUEBScheme2” parameter is set to enabled, then the second reserved bit in “sl-NumReservedBits” may be used to indicate whether the TBS determination is based on the slot from the first or the second starting symbol.

When a PSSCH and/or PSCCH communications begins from a second starting symbol of a slot, one or more processing time constraints may be determined and/or implemented by UE 110. In some implementations, a time gap may be implemented between PSSCH and PSFCH. In such scenarios, the first PSFCH occasion may be at least two or three slots after a PSSCH transmission. In other implementations, a time gap may be implemented between a PSSCH communications and a PSFCH communication based on a predefined configuration. For example, the first PSFCH occasion may be designated for all scenarios to be at least two, three, or another number of slots after a PSSCH communication.

In yet other implementations, a time gap may be implemented between a PSSCH communication and a PSFCH communication in a different manner, such as based on a resource pool configuration being implemented for the SL communications. For example, a resource pool configuration may include, or trigger, the implementation of a time gap between the PSSCH communication and the PSFCH communication that is greater than three slots. In some implementations, a time gap implementation may be based on a corresponding resource pool configuration regardless of whether the PSSCH communication and/or PSCCH communication starts from the first starting symbol or the second starting symbol in a slot. In such implementations, the time gap may be greater than 3 slots.

In other implementations, a time gap implementation may be based on a corresponding resource pool configuration when the PSSCH communication and/or PSCCH communication starts from the second starting symbol in a slot. For PSSCH communications and/or PSCCH communications that start from the first starting slot symbol in the slot, a legacy time gap may be implemented (e.g., a time gap of 2 or 3 slots.). In other implementations, the approach to implementing a time gap (e.g., whether the first starting symbol or second starting symbol is dispositive) may further depend on a category or type of resource pool configuration being implemented.

Referring to FIG. 2, process 200 may include determining SL resources (at 220). For example, UE 110-2 may determine SL resources upon receiving a PSCCH communication and/or PSSCH communication from UE 110-1. UE 110-2 may determine SL resources based on a resource pool configuration implemented by UE 110-1. The resource pool configuration may be indicated by UE 110-1 as control information and/or by base station 122 (e.g., where base station 122 configures each of UE 110-1 and UE 110-2 to use the resource pool configuration for SL communications). In some implementations, UE 110-2 may listen or monitor for SL communications using 4G LTE techniques and/or 5G NR techniques. In such scenarios, UE 110-2 detecting SL signaling for communications received during an LTE sensing window and/or an NR sensing window. As described herein, UE 110-2 may process and resolve signals received in overlapping LTE sensing windows and NR sensing windows by sharing the earliest detected information.

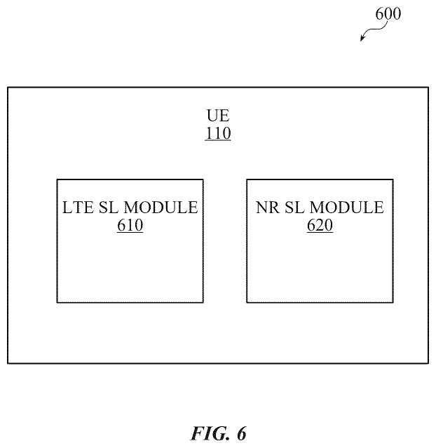

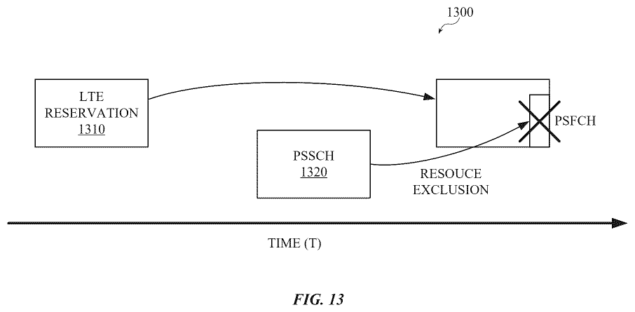

FIG. 6 is a diagram of an example 600 of an LTE SL module 610 and an NR SL module 620 of UE 110 according to one or more implementations described herein. LTE SL module 610 may include one or more combinations of software and hardware components described herein (see, for example, components 1310, 1308, 1306, 1304B, 1304E, 1304G, etc., of FIG. 13) which are configured or otherwise capable to perform one or more of the operations described herein. Similarly, NR SL module 620 may include one or more combinations of software and hardware components described herein (see, for example, components 1310, 1308, 1306, 1304C, 1304E, 1304G, etc., of FIG. 13) which are configured or otherwise capable to perform one or more of the operations described herein.

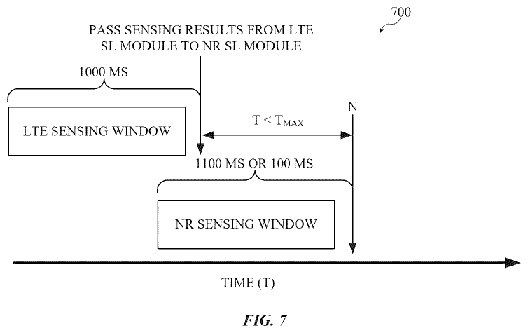

Generally, LTE SL module 610 may be configured to facilitate or enable UE 110 to engage in SL communications using LTE signals, resources, configurations, numerologies, etc. Additionally, or alternatively, NR SL module 620 may be configured to facilitate or enable UE 110 to engage in SL communications using NR signals, resources, configurations, numerologies, etc. Non-limiting examples of processes and operations that may be performed by LTE SL module 610 and an NR SL module 620 (and/or other components of UE 110) are described below with reference to FIGS. 7-11.

FIG. 7 is a diagram of an example 700 of overlapping LTE and NR sensing windows and sharing LTE sensing results according to one or more implementations described herein. LTE SL module 610 may be configured to listen for, detect, and/or receive LTE SL signals. As described herein, an LTE SL signal may include an SL-U signal from another UE 110 using LTE-defined resources, configurations, numerologies, etc. LTE SL module 610 may be configured to listen for and receive an LTE SL signal during an LTE sensing window with a duration of 1000 milliseconds (ms). NR SL module 620 may be configured to listen for, detect, and/or receive NR SL signals. As described herein, an NR SL signal may include an SL-U signal from another UE 110 using NR-defined resources, configurations, numerologies, etc. As show, NR SL module 620 may be configured to listen for and receive the NR SL signal during an NR sensing window with a duration of either 1100 ms or 100 ms. The duration of the NR sensing window may be based on resource pool configuration implemented by UE 110.

N may be a time at the end of the NR sensing window or the beginning of a slot for NR resources selection, reselection, re-evaluation, or pre-emption. T′ may be a time when sensing results of the LTE SL signal are shared with NR SL module 620. T′_{MAX} may depend on the implementation. For example, T′_{MAX} may be 1100 ms per the NR sensing window, 1000 ms per the LTE sensing window size, or per the resource pool configuration. When T′ is less than or equal to T′_{MAX}, NR SL module 620 may be configured to use the information received from the LTE SL signal. As shown, this may apply to scenarios in which the LTE sensing window and NR sensing window overlap with one another. That is, NR SL module 620 may be configured to use information about the LTE SL signal when the information is received within the NR sensing window and within a threshold time from N. NR SL module 620 may be configured ignore such information if received before the NR sensing window or before the threshold time. In such scenarios, NR SL module 620 may, for example, wait and receive an NR SL signal and proceed with NR SL resource selection, reselection, re-evaluation, etc., based on the NR SL signal.

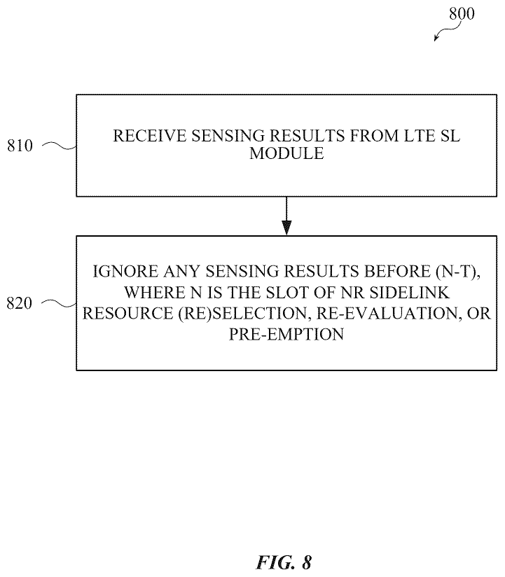

FIG. 8 is a diagram of an example of a process 800 for sharing and using sensing results according to one or more implementations described herein. Process 800 may be implemented by UE 110 and/or a combination of LTE SL module 610 and NR SL module 620. In some implementations, some or all of process 800 may be performed by one or more other systems or devices, including one or more of the devices of FIG. 1. Additionally, process 800 may include one or more fewer, additional, differently ordered and/or arranged operations than those shown in FIG. 8, including other processes and/or operations discussed herein. For example, process 800 may include operations preceding, performed in parallel with, and/or following one or more of the depicted operations. Furthermore, some or all of the operations of process 800 may be performed independently, successively, simultaneously, etc., of one or more of the other operations of process 800. As such, the techniques described herein are not limited to a number, sequence, arrangement, timing, etc., of the operations or process depicted in FIG. 8.

As shown, process 800 may include receiving and processing an LTE SL signal using LTE SL module 610 (block 810). For example, UE 110-2 may receive and process an LTE SL signal from UE 110-1. In some implementations, UE 110-2 may receive and detect the signal using an LTE SL module 610 of UE 110-2. Process 800 may include receiving a notification of the LTE SL signal using NR SL module 620 (block 820). For example, upon receiving and processing an LTE SL signal, LTE SL module 610 may be configured to share or communicate the LTE SL signal or information about the LTE SL signal (e.g., sensing information) to NR SL module 620.

UE 110 may determine whether the LTE SL signal or sensing information is received (T′) by NR SL module 620 within a threshold time (T or T_{MAX}) of a slot (N) for NR SL resource selection, reselection, re-evaluation, or pre-emption (block 830). When the sensing information or results from LTE SL module 610 are received by NR SL module 620 at a time (T′) prior to N minus a time threshold (T), NR SL module 620 may ignore the information or results. N may include a slot for NR sidelink resource selection, reselection, re-evaluation, or pre-emption. By contrast, when sensing information or results from LTE SL module 610 are received by NR SL module 620 at a time (T′) after N minus a time threshold (T or T_{MAX}), NR SL module 620 may use the information or results from LTE SL module 610.

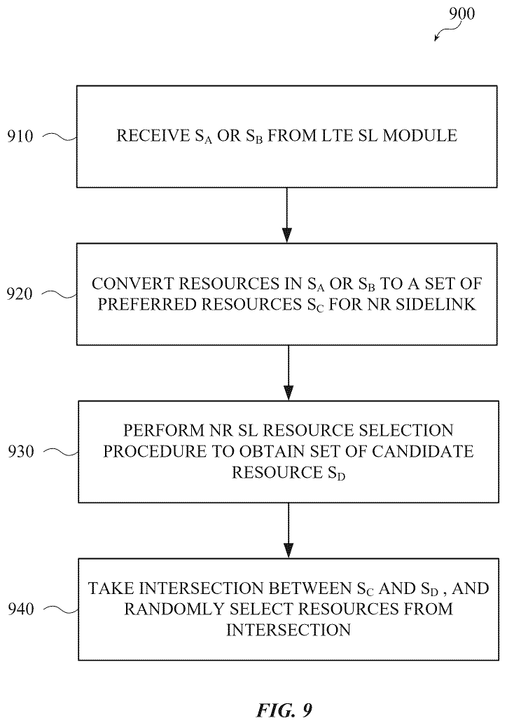

FIG. 9 is a diagram of an example process 900 for using shared LTE signal results according to one or more implementations described herein. Process 900 may be implemented by UE 110 and/or a combination of LTE SL module 610 and NR SL module 620. In some implementations, some or all of process 900 may be performed by one or more other systems or devices, including one or more of the devices of FIG. 1. Additionally, process 900 may include one or more fewer, additional, differently ordered and/or arranged operations than those shown in FIG. 9, including other processes and/or operations discussed herein. For example, process 900 may include operations preceding, performed in parallel with, and/or following one or more of the depicted operations. Furthermore, some or all of the operations of process 900 may be performed independently, successively, simultaneously, etc., of one or more of the other operations of process 900. As such, the techniques described herein are not limited to a number, sequence, arrangement, timing, etc., of the operations or process depicted in FIG. 9. In some implementations, example process 900 may be implemented when an LTE SL sub-channel has partially overlapped with an NR SL sub-channel.

As shown, process 900 may include receiving an indication of S_{A} or S_{B} from LTE SL module 610 (block 910). For example, NR SL module 620 may receive an indication of S_{A} or S_{B} from LTE SL module 610. “S” as used herein (e.g., S_{A}, S_{B}, S_{C}, etc.) may refer to a set of candidate resources which could be used for sidelink transmissions. Receiving an indication of S_{A} or S_{B} may correspond to receiving an LTE SL signal from LTE SL module 610 as described elsewhere herein. Process 900 may also include converting resources in S_{A} or S_{B} to a set of preferred resources S_{c} for NR SL communications (block 920). For example, NR SL module 620 may convert resources in S_{A} or S_{B} to a set of preferred resources for NR SL communications.

In some implementations, converting candidate resources in S_{A} or S_{B} from to preferred resources for NR SL communication may include one or more techniques. In some implementations, an NR SL sub-channel may only be considered a preferred resource for NR SL communications when all of the resource blocks (RBs) of the NR SL sub-channel are within the sub-channel of a resource in S_{A} or S_{B}. In some implementations, an NR SL sub-channel may only be considered a preferred resource for NR SL communications when at least a threshold number, or a threshold percentage, of RBs of the NR SL sub-channel are within the sub-channel of a resource in S_{A} or S_{B}. In such implementations, the threshold number, or a threshold percentage, of RBs may be specified and/or particular to a corresponding SL resource pool configuration (e.g., a resource pool configuration being implemented by UEs 110).

Process 900 may also include performing an NR SL resource selection procedure to obtain a set of candidate resources SD (block 930). For example, NR SL module 620 may performing an NR SL resource selection procedure to obtain a set of candidate resources S_{D}.

Process 900 may also include determining an intersection of resources between candidate resources S_{D} and preferred resources S_{c} and selecting resources from the intersection of resources (block 940). For example, NR SL module 620 may determine an intersection of resources between candidate resources S_{D} and preferred resources S_{c} and select resources from the intersection of resources. An intersection between candidate resources S_{D} and preferred resources S_{c} may include resources that overlap between a set of candidate resource and a set of preferred resources. In some implementations, the selection of resources from the intersection may be random.

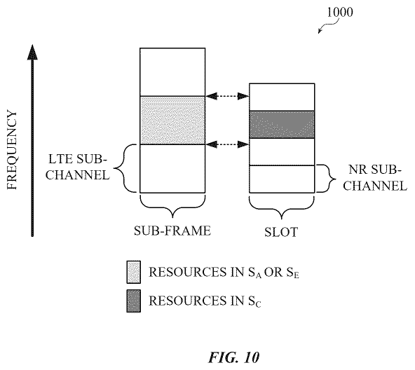

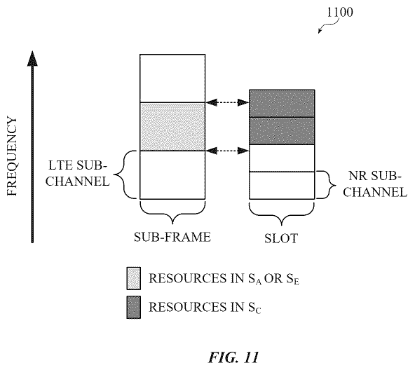

FIGS. 10-11 are diagrams of examples 1000 and 1100 using shared LTE signal results when an LTE SL sub-channel overlaps with an NR SL sub-channel according to one or more implementations described herein. As shown, examples 1000 and 1100 may include LTE-subchannel resources S_{A} or S_{B} and NR sub-channel resources S_{c} that overlap with one another along a frequency axis. Example 1000 may include a scenario in which an NR SL sub-channel is considered a preferred resource for NR SL communications because all of the RBs of the NR SL sub-channel are within the sub-channel of a resource in S_{A} or S_{B}. By contrast, example 1100 may include a scenario in which an NR SL sub-channel may is considered a preferred resource for NR SL communications when at least a threshold number, or a threshold percentage, of RBs of the NR SL sub-channel are within the sub-channel of a resource in S_{A} or S_{B}.

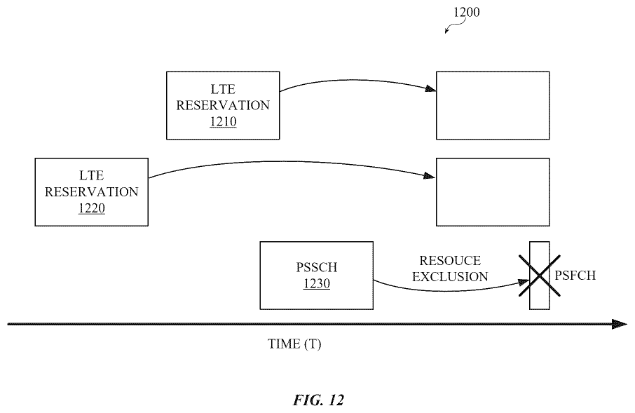

Referring to FIG. 2, process 200 may include using SL resources for PSFCH communication (230). For example, UE 110-2 may use SL resources for PSFCH communications. In some implementations, UE 110-2 may determine or assess SL resources reserved by other UEs 110, which may include LTE or NR resources. As described below with referenced to FIGS. 12-13, UE 110-2 may apply one or more rules to determine which SL resources are to be used for PSFCH communications. UE 110-2 may determine, schedule, reserve, etc., SL resources for PSFCH communications while determining SL resources (at 220).

FIGS. 12-13 are diagrams of examples 1200 and 1300 of preventing PSFCH transmissions from overlapping with LTE transmissions according to one or more implementations described herein. As described herein, UEs 110 may engage in SL communications using LTE resources and/or NR resources. Each set of resources may pertain to a time domain and a frequency domain. When reserved SL resources do not overlap in either a time domain or a frequency domain, SL communications using the resources may proceed.

Example 1200 includes LTE reservation 1210, LTE reservation 1220, and NR PSSCH 1230. The LTE transmissions and NR transmissions may be from the same UE 110 or from different UEs 110. SL communications using these resources may proceed because they do not overlap in a time domain or a frequency domain. However, corresponding LTE reservations 1240 and 1250 overlap in a time domain (but not a frequency domain) with an PSFCH transmission corresponding to NR PSSCH transmission 1230. As such, UE 110 may be configured to determine and proceed when one or more exceptions apply to such a scenario. In some implementations, UE 110 may compare a priority of the NR PSFCH transmission with LTE reservations 1240 and 1250 and only proceed when the priority of the NR PSFCH transmission is higher than the priority of LTE reservations 1240 and 1250. In some implementations, UE 110 may compare a priority of the NR PSFCH transmission with a threshold priority of a corresponding NR SL resource pool and only proceed when the priority of the NR PSFCH transmission is higher than the threshold of the preconfigured threshold priority. In some implementations, UE 110 may compare a priority of LTE reservations 1240 and 1250 with a threshold priority of a corresponding NR SL resource pool and only proceed when the priority of LTE reservations 1240 and 1250 are less than the preconfigured threshold priority. In some implementations, UE 110 may be configured to proceed with the NR PSFCH transmission when any, two or more, or all of the foregoing exceptions apply.

Example 1300 includes LTE reservation 1310 and NR PSSCH 1320. The LTE transmission and NR transmission may be from the same UE 110 or from different UEs 110. SL communications using these resources may proceed because they do not overlap in a time domain or a frequency domain. However, corresponding LTE reservation 1330 overlaps with an PSFCH transmission corresponding to NR PSSCH transmission 1320 in a time domain and a frequency domain. As such, the UE 110 of the PSFCH transmission may be configured to proceed one or more ways.

In some implementations, UE 110 may be configured to detect the overlap and not communicate the PSFCH transmission. In some implementations, UE 110 may be configured to compare a priority of the PSFCH transmission with a priority of the conflicting LTE SL reservation (LTE reservation 1330) and proceed with the PSFCH transmission when the priority of the PSFCH transmission is greater. In some implementations, UE 110 may be configured to proceed with the PSFCH transmission when the priority of the PSFCH transmission is the highest priority among LTE SL reservations compared by UE 110. In some implementations, UE 110 may be configured to proceed with the PSFCH transmission when the priority of the PSFCH transmission is higher than a pre-configured threshold of a corresponding NR resource pool.

In some implementations, UE 110 may be configured to proceed with the PSFCH transmission when the priority of the PSFCH transmission is the highest priority among LTE SL reservations compared by UE 110 and the total number of SL transmissions is less than a threshold number of SL transmissions. In some implementations, unless one or more (or all) of the foregoing conditions apply, UE 110 may not proceed with the PSFCH transmission. In yet other implementations, one or more of the foregoing conditions may apply based on a cast type (e.g., unicast, multicast, broadcast, groupcast).

For example, in a groupcast scenario, one or more of the foregoing conditions may apply based on whether a groupcast option 1 applies (e.g., negative acknowledgement (NACK only) or a groupcast option 2 applies (e.g., acknowledgement and negative acknowledgement (ACK/NACK). As another example, in a unicast scenario, UE 110 may be configured to proceed with the PSFCH transmission when the priority of the PSFCH transmission is the highest priority among LTE SL reservations compared by UE 110; and in a groupcast option 1 scenario, UE 110 may be configured to proceed with the PSFCH transmission when the priority of the PSFCH transmission is the highest priority among LTE SL reservations compared by UE 110 and the total number of SL transmissions is less than a threshold number of SL transmissions Referring to FIG. 2, process 200 may include using SL resources for PSSCH communications (at 240). For example, UE 110-2 may use SL resources (e.g., determined at 220) for communicating with UE 110-1 via PSSCH communications. In doing so, UE 110-2 may implement one or more of the techniques for SL-U communications described herein, including the evaluation, reservation, and use of LTE and/or NR resources for doing so.

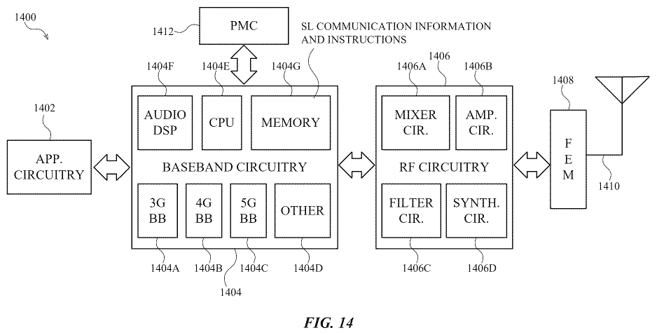

FIG. 14 is a diagram of an example of components of a device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be included in a UE or a RAN node. In some implementations, the device 1400 can include fewer elements (e.g., a RAN node may not utilize application circuitry 1402, and instead include a processor/controller to process IP data received from a CN or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1400. In some implementations, processors of application circuitry 1402 can process IP data packets received from an EPC.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuity 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, etc.). The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E. The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1404G may receive and store one or more configurations, instructions, and/or other types of information for SL signaling that supports two candidate starting symbols within a slot. Slots with two candidate starting symbols may not be applicable to slots with feedback channel resources. Slots with two candidate starting symbols may be preconfigured. Slot structures and solutions for determining TBS, for slots supporting two candidate starting symbols, may also be included, as well as solutions for processing time constraints and time gaps between reception of slots supporting two starting candidate symbols and providing feedback regarding such slots. Memory 1404G may receive and store one or more configurations, instructions, and/or other types of information for sharing information during overlapping LTE and NR sensing windows, sharing LTE and NR sub-channel resources, and avoiding NR feedback transmission that may overlap with LTE transmissions.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1404 and the application circuitry 1402 can be implemented together such as, for example, on a system on a chip (SOC).

In some implementations, the baseband circuitry 1404 can provide for communication compatible with one or more radio technologies. For example, in some implementations, the baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path. In some implementations, the mixer circuitry 1406A of the receive signal path can be configured to down-convert RF signals received from the FEM circuitry 1408 based on the synthesized frequency provided by synthesizer circuitry 1406D. The amplifier circuitry 1406B can be configured to amplify the down-converted signals and the filter circuitry 1406C can be a low-pass filter (LPF) or band-pass filter (BPF) configured to remove unwanted signals from the down-converted signals to generate output baseband signals. Output baseband signals can be provided to the baseband circuitry 1404 for further processing. In some implementations, the output baseband signals can be zero-frequency baseband signals, although this is not a requirement. In some implementations, mixer circuitry 1406A of the receive signal path can comprise passive mixers, although the scope of the implementations is not limited in this respect.

In some implementations, the mixer circuitry 1406A of the transmit signal path can be configured to up-convert input baseband signals based on the synthesized frequency provided by the synthesizer circuitry 1406D to generate RF output signals for the FEM circuitry 1408. The baseband signals can be provided by the baseband circuitry 1404 and can be filtered by filter circuitry 1406C.

In some implementations, the mixer circuitry 1406A of the receive signal path and the mixer circuitry 1406A of the transmit signal path can include two or more mixers and can be arranged for quadrature down conversion and up conversion, respectively. In some implementations, the mixer circuitry 1406A of the receive signal path and the mixer circuitry 1406A of the transmit signal path can include two or more mixers and can be arranged for image rejection (e.g., Hartley image rejection). In some implementations, the mixer circuitry 1406A of the receive signal path and the mixer circuitry 1406A can be arranged for direct down conversion and direct up conversion, respectively. In some implementations, the mixer circuitry 1406A of the receive signal path and the mixer circuitry 1406A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1406 can include analog-to-digital converter (ADC) and digital-to-analog converter (DAC) circuitry and the baseband circuitry 1404 can include a digital baseband interface to communicate with the RF circuitry 1406.

In some dual-mode implementations, a separate radio IC circuitry can be provided for processing signals for each spectrum, although the scope of the implementations is not limited in this respect.

In some implementations, the synthesizer circuitry 1406D can be a fractional−N synthesizer or a fractional N/N+1 synthesizer, although the scope of the implementations is not limited in this respect as other types of frequency synthesizers can be suitable. For example, synthesizer circuitry 1406D can be a delta-sigma synthesizer, a frequency multiplier, or a synthesizer comprising a phase-locked loop with a frequency divider.

The synthesizer circuitry 1406D can be configured to synthesize an output frequency for use by the mixer circuitry 1406A of the RF circuitry 1406 based on a frequency input and a divider control input. In some implementations, the synthesizer circuitry 1406D can be a fractional N/N+1 synthesizer.

In some implementations, frequency input can be provided by a voltage-controlled oscillator (VCO), although that is not a requirement. Divider control input can be provided by either the baseband circuitry 1404 or the applications circuitry 1402 depending on the desired output frequency. In some implementations, a divider control input (e.g., N) can be determined from a look-up table based on a channel indicated by the applications circuitry 1402.

Synthesizer circuitry 1406D of the RF circuitry 1406 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1406D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1406 can include an IQ/polar converter.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the FEM circuitry 1408 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1406). The transmit signal path of the FEM circuitry 1408 can include a power amplifier (PA) to amplify input RF signals (e.g., provided by RF circuitry 1406), and one or more filters to generate RF signals for subsequent transmission (e.g., by one or more of the one or more antennas 1410).

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics.

While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

In some implementations, the PMC 1412 can control, or otherwise be part of, various power saving mechanisms of the device 1400. For example, if the device 1400 is in an RRC_Connected state, where it is still connected to the RAN node as it expects to receive traffic shortly, then it can enter a state known as discontinuous reception mode (DRX) after a period of inactivity. During this state, the device 1400 can power down for brief intervals of time and thus save power.

If there is no data traffic activity for an extended period of time, then the device 1400 can transition off to an RRC_Idle state, where it disconnects from the network and does not perform operations such as channel quality feedback, handover, etc. The device 1400 goes into a very low power state and it performs paging where again it periodically wakes up to listen to the network and then powers down again. The device 1400 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1402 and processors of the baseband circuitry 1404 can be used to execute elements of one or more instances of a protocol stack. For example, processors of the baseband circuitry 1404, alone or in combination, can be used execute Layer 3, Layer 2, or Layer 1 functionality, while processors of the baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

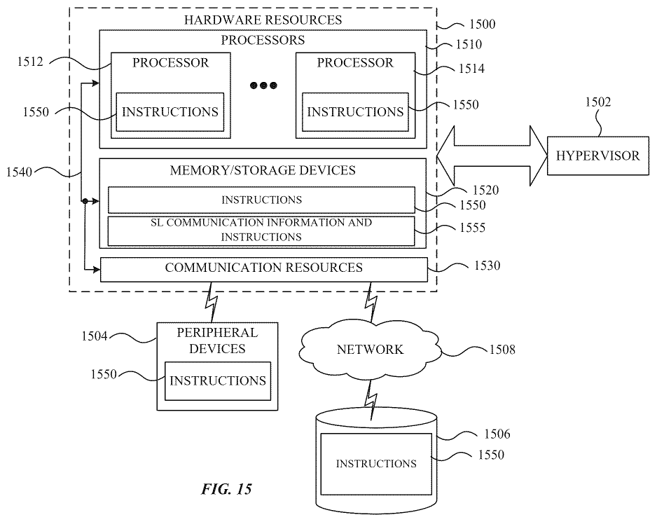

FIG. 15 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For implementations where node virtualization (e.g., NFV) is utilized, a hypervisor may be executed to provide an execution environment for one or more network slices/sub-slices to utilize the hardware resources 1500

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1520 may receive and store one or more configurations, instructions, and/or other type of information 1555 for SL signaling that supports two candidate starting symbols within a slot. Slots with two candidate starting symbols may not be applicable to slots with feedback channel resources. Slots with two candidate starting symbols may be preconfigured. Slot structures and solutions for determining TBS, for slots supporting two candidate starting symbols, may also be included, as well as solutions for processing time constraints and time gaps between reception of slots supporting two candidate starting symbols and providing feedback regarding such slots. Memory/storage devices 1520 may receive and store one or more configurations, instructions, and/or other type of information 1555 for sharing information during overlapping LTE and NR sensing windows, sharing LTE and NR sub-channel resources, and avoiding NR feedback transmission that may overlap with LTE transmissions.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a universal serial bus (USB)), cellular communication components, NFC components, Bluetooth® components (e.g., Bluetooth® low energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user equipment (UE), comprising: a memory; and one or more processors configured to, when executing instructions stored in the memory, cause the UE to: determine a slot configuration for unlicensed spectrum sidelink (SL-U) communications, the slot configuration including a slot with two candidate starting symbols; and communicate an SL-U communication using one of the two candidate starting symbols as a starting symbol for the SL-U communication based at least in part on the slot configuration.

In example 2, which may also include one or more of the examples described herein, the SL-U signal includes feedback resources in a slot other than the slot having the two candidate starting symbols. In example 3, which may also include one or more of the examples described herein, the slot configuration is based on an SL resource pool pre-configuration. In example 4, which may also include one or more of the examples described herein, the SL-U signal includes a periodicity for slots with the two candidate starting symbols.

In example 5, which may also include one or more of the examples described herein, a slot configuration of the SL-U signal is used for a physical sidelink (SL) shared channel (PSSCH) and a physical SL control channel (PSCCH). In example 6, which may also include one or more of the examples described herein, the slot with the two candidate starting symbols includes two automatic gain control (AGC) symbols. In example 7, which may also include one or more of the examples described herein, when a physical sidelink (SL) shared channel (PSSCH) is transmitted from a first starting symbol, of the two candidate starting symbols, PSSCH symbols are mapped over a second AGC symbol of the two AGC symbols.

In example 8, which may also include one or more of the examples described herein, a second starting symbol, of the two candidate starting symbols, is positioned at a symbol index other than a symbol index assigned to a demodulated reference signal (DM-RS) symbol. In example 9, which may also include one or more of the examples described herein, a transport block size (TBS) determination of the SL-U signal is based on a first candidate starting symbol of the two candidate starting symbols. In example 10, which may also include one or more of the examples described herein, a transport block size (TBS) determination of the SL-U signal is based on a second candidate starting symbol of the two candidate starting symbols.

In example 11, which may also include one or more of the examples described herein, a transport block size (TBS) determination of the SL-U signal is based on sidelink (SL) control information (SCI). In example 12, which may also include one or more of the examples described herein, a time gap between a physical sidelink (SL) shared channel (PSSCH) and a physical SL feedback channel (PSFCH) is based on a SL resource pool pre-configuration associated with the SL-U signal. In example 13, which may also include one or more of the examples described herein, the time gap of the SL resource pool pre-configuration associated with the SL-U signal applies when a physical sidelink (SL) shared channel (PSSCH) starts from the second candidate starting symbol of the two candidate starting symbols.

In example 14, which may also include one or more of the examples described herein, a user equipment (UE) may comprise: a memory; and one or more processors configured to, when executing instructions stored in the memory, cause the UE to: receive sensing results from a signal corresponding to a long-term evolution (LTE) signal, the sensing results indicating an LTE resource allocation for sidelink (SL) communications; convert the LTE resource allocation to a new radio (NR) resource allocation; select NR resources based on the converted NR resource allocation; and communicate with another UE using the selected NR resources.

In example 15, which may also include one or more of the examples described herein, the LTE resource allocation is received within a threshold time from a slot for NR SL resource selection. In example 16, which may also include one or more of the examples described herein, the LTE resource allocation is received within an LTE sensing window. In example 17, which may also include one or more of the examples described herein, the LTE resource allocation is received within an NR sensing window. In example 18, which may also include one or more of the examples described herein, the threshold time is based on an SL resource pool pre-configuration.

In example 19, which may also include one or more of the examples described herein, the NR resource allocation is based on a number of NR resource blocks (RBs) included in a frequency range corresponding to the LTE resource allocation. In example 20, which may also include one or more of the examples described herein, the NR resource allocation is based on a threshold number of NR resource blocks (RBs) included in a frequency range corresponding to the LTE resource allocation. In example 21, which may also include one or more of the examples described herein, the NR resource allocation is based on a threshold percentage of NR resource blocks (RBs) included in a frequency range corresponding to the LTE resource allocation.

In example 22, which may also include one or more of the examples described herein, the NR resource allocation comprises physical SL feedback channel (PSFCH) resources that overlap in a time domain with reserved LTE resources of a lower priority than the NR resource allocation. In example 23, which may also include one or more of the examples described herein, a priority of the NR resource allocation of the PSFCH resources is higher than a highest priority of LTE SL transmissions of the reserved LTE resources. In example 24, which may also include one or more of the examples described herein, a priority of the NR resource allocation of the PSFCH resources is higher than a pre-configured priority threshold of a corresponding NR resource pool.

In example 25, which may also include one or more of the examples described herein, a number of LTE SL transmissions, of the reserved LTE resources, is less than a pre-configured threshold number of LTE SL transmissions. In example 26, which may also include one or more of the examples described herein, the NR resource allocation comprises physical SL feedback channel (PSFCH) resources that overlap in a time domain and a frequency domain with reserved LTE resources of a lower priority than the NR resource allocation. In example 27, which may also include one or more of the examples described herein, a priority of the NR resource allocation of the PSFCH resources is higher than a priority of LTE SL transmissions of the reserved LTE resources. In example 28, which may also include one or more of the examples described herein, a priority of the NR resource allocation of the PSFCH resources is higher than a highest priority of LTE SL transmissions. In example 29, which may also include one or more of the examples described herein, a priority of the NR resource allocation of the PSFCH resources is higher than a highest priority of LTE SL transmissions and a number of the LTE SL transmissions is less than a pre-configured threshold number of LTE SL transmissions.

In example 30, which may also include one or more of the examples described herein, a method, performed by a user equipment (UE), may comprise: determining a slot configuration for unlicensed spectrum sidelink (SL-U) communications, the slot configuration including a slot with two candidate starting symbols; and communicating an SL-U communication using one of the two candidate starting symbols as a starting symbol for the SL-U communication based at least in part on the slot configuration. In example 31, which may also include one or more of the examples described herein, a method, performed by a user equipment (UE), may comprise: receiving sensing results from a signal corresponding to a long-term evolution (LTE) signal, the sensing results indicating an LTE resource allocation for sidelink (SL) communications; converting the LTE resource allocation to a new radio (NR) resource allocation; selecting NR resources based on the converted NR resource allocation; and communicate with another UE using the selected NR resources.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. An apparatus for a user equipment (UE), comprising:
a memory; and
one or more processors coupled to the memory and, when executing instructions stored in the memory, configured to:
receive a sidelink configuration indicating a first candidate starting symbol and a second candidate starting symbol; and
perform a sidelink transmission, based on the sidelink configuration, using one of the first candidate starting symbol or the second candidate starting symbol as a starting symbol in a slot that is not configured with physical sidelink feedback channel (PSFCH) resources.

2. The apparatus of claim 1, wherein the PSFCH resources are included in a slot other than slots supporting the first candidate starting symbol and the second candidate starting symbol.

3. The apparatus of claim 1, wherein the sidelink configuration is per resource pool.

4. The apparatus of claim 1, wherein the sidelink configuration includes a periodicity for slots supporting the first candidate starting symbol and the second candidate starting symbol.

5. The apparatus of claim 1, wherein a sidelink configuration is used for a physical sidelink shared channel (PSSCH) and a physical sidelink control channel (PSCCH).

6. The apparatus of claim 1, wherein the one or more processors are further configured to, when the sidelink transmission uses a later symbol of the first candidate starting symbol and the second candidate starting symbol as the starting symbol, perform an initial AGC at a beginning of a slot and an additional automatic gain control (AGC) adjustment prior to the sidelink transmission.

7. The apparatus of claim 6, wherein, when a physical sidelink shared channel (PSSCH) is transmitted from the first candidate starting symbol, PSSCH symbols are mapped over a second AGC symbol.

8. The apparatus of claim 1, wherein the sidelink configuration provides a set of symbol indices respectively indicating a location of the first candidate starting symbol and the second candidate starting symbol.

9. The apparatus of claim 1, wherein a transport block size (TBS) determination for the sidelink transmission is based on the sidelink configuration indicating the first candidate starting symbol and the second candidate starting symbol.

10. The apparatus of claim 1, wherein a transport block size (TBS) determination for the sidelink transmission is based on a configuration indication provided by a higher layer.

11. The apparatus of claim 1, wherein a transport block size (TBS) determination for the sidelink transmission is based on sidelink control information (SCI).

12. The apparatus of claim 1, wherein a time gap between a physical sidelink shared channel (PSSCH) and a physical SL feedback channel (PSFCH) is based on the sidelink configuration.

13. The apparatus of claim 12, wherein the time gap applies in response to the second candidate starting symbol being used.

14. A user equipment (UE), comprising:
a memory; and
one or more processors coupled to the memory and, when executing instructions stored in the memory, configured to cause the UE to:
receive sensing results from a long-term evolution (LTE) signal starting from a threshold time prior to a slot for NR SL resource selection, the sensing results indicating an LTE resource allocation for a sidelink communication;
select NR resources based on the LTE resource allocation; and
communicate with another UE using the NR resources.

15-16. (canceled)

17. The UE of claim 14, wherein the LTE resource allocation is received within an NR sensing window.

18. The UE of claim 14, wherein the threshold time is 1100 milliseconds.

19-25. (canceled)

26. The UE of claim 14, wherein the NR resources comprise physical SL feedback channel (PSFCH) resources that overlap in a time domain and a frequency domain with reserved LTE resources of a lower priority.

27-29. (canceled)

30. A method, performed by a user equipment (UE), comprising:
receiving a sidelink configuration indicating a first candidate starting symbol and a second candidate starting symbol; and
performing a sidelink transmission, based on the sidelink configuration, using one of the first candidate starting symbol or the second candidate starting symbol as a starting symbol in a slot that is not configured with physical sidelink feedback channel (PSFCH) resources.

31. The method of claim 30, wherein the sidelink configuration provides two sets of symbol indices respectively indicating locations of the first candidate starting symbol and the second candidate starting symbol.

32. The method of claim 30, wherein a transport block size (TBS) determination for the sidelink transmission is based on the sidelink configuration indicating the first candidate starting symbol and the second candidate starting symbol.

33-37. (canceled)
